(19) United States
(12) Patent Application Publication
(10) Pub. No.: US 2008/0117556 A1
(43) Pub. Date: May 22, 2008

(54) SUPPRESSION CIRCUIT WITH HIGH VOLTAGE ISOLATION AND SURGE SUPPRESSION

(76) Inventors: Wei-Chun TSAO, Taipei (TW); Chien-Ru Lin, Taipei (TW)

Correspondence Address: Dr. BANGER SHIA, 102 Lindencrest Ct., Sugar Land, TX, 77479-5201, US

(21) Appl. No.: 11/935,850

(22) Filed: Nov. 6, 2007

(30) Foreign Application Priority Data
Nov. 20, 2006 (TW) 95142740

(51) Int. Cl. H02H 9/04

(52) U.S. Cl. 361/56; 361/118

(57) ABSTRACT

A suppression circuit with high voltage isolation and surge suppression, which utilizes a safety capacitor to replace the surge protector and the capacitor in a conventional circuit, is provided. Therefore, the cost is greatly reduced. Via the characteristic of the safety capacitor, the suppression circuit can simultaneously meet the requirements of high voltage isolation and surge suppression. The design of the high-frequency shielding can be simplified with surface mount technology (SMT), and assembling time can be reduced. Moreover, the high-frequency shielding performance can be improved.

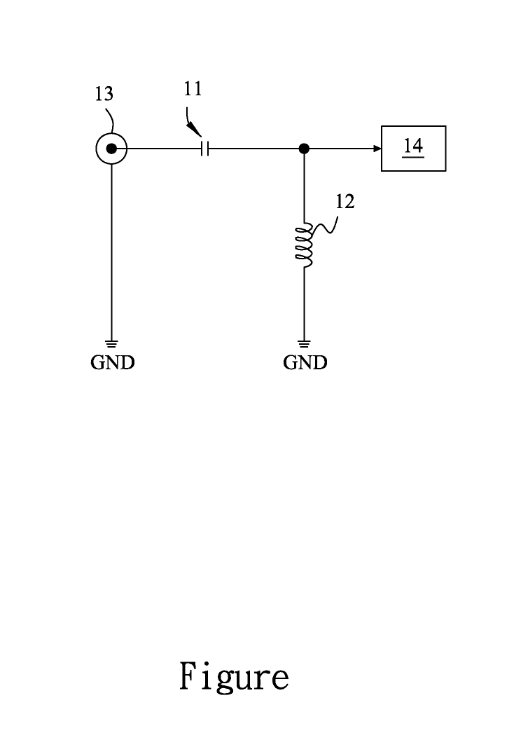

### BACKGROUND OF THE INVENTION

1. Field of Invention

The invention relates to a suppression circuit applying to connect a high-frequency transmitting circuit such as a coaxial cable and, more particularly, to a suppression circuit with high voltage isolation and surge suppression.

2. Description of the Related Art

Surge commonly has the same meaning of current pulse or voltage pulse Generally speaking, there are two main reasons for the generation of the surge. One kind of surge is the thunder surge caused by thunder and lightning; the other one is the on-off surge caused by switching on or switching off a circuit. The thunder surge is generated by the nature world, so it is necessary to add proper overload protection. The on-off surge is the surge generated at the instant of the conducting of the circuit. If a circuit is designed without so-called urge protector? the circuit will operate incorrectly easily because of the on-off surge; in further serious situation, the circuit will be damaged because of the overload, or the lifetime of the electronic components in the circuit will be decreased because of the long time surge interference. Therefore, it is necessary to add surge protection in the circuit design.

Taking the circuit of a coaxial cable connector for example, in order to meet the EN 60950-1 standard, the circuit design should have isolation effect for Direct Current (DC) 1414V and Alternating Current (AC) 1000V. However, if the circuit needs to meet the EN 60950-1 standard, it must bear 4KV, 2000 A thunder surge. In current market, the familiar practice is utilizing surge absorber or gas tube described as follows.

The varistor, which is commonly called as surge absorber, is a resistor of which the resistance value is variable with the change of the voltage value. The resistance value of the varistor will quickly decrease, and the varistor is nearly short-circuited, and the surge is led into the varistor and dissipated in form of heat, so that the function of stabilizing voltage and absorbing surge voltage can be achieved, and the circuit components can be avoided being damaged by the surge voltage.

The main effect of the gas tube, as the same as the effect of the varistor, is to suppress the over high surge voltage. However, whichever the component above is used, the cost is so high that it has no competitiveness in the tense competition of the industry.

### BRIEF SUMMARY OF THE INVENTION

To solve the above problems, the invention provides a suppression circuit with high voltage isolation and surge suppression, which can reduce the cost greatly and meet the requirements of high voltage isolation and surge suppression.

A suppression circuit with high voltage isolation and surge suppression disclosed in the invention includes a safety capacitor and an inductance. The safety capacitor is coupled with a signal source and a modulator; one end of the inductance is coupled with the safety capacitor and the modulator, and the other end of the inductance is grounded to form a bypass. When the surge is transmitted from the signal source, the circuit is able to endure the surge via the characteristic of the safety capacitor, so that the surge is not be transmitted to the modulator or the other components. On the other hand, the bypass formed by the grounded inductance can lead the high voltage signal to the ground to achieve the effect of the high voltage isolation. By this design, the circuit can simultaneously meet the requirements of high voltage isolation and surge suppression, and the cost can be reduced because the safety capacitor is cheaper than the other conventional components.

These and other features, aspects, and advantages of the present invention will become better understood with regard to the following description, appended claims, and accompanying drawings.

### BRIEF DESCRIPTION OF THE DRAWINGS

The figure is a schematic diagram showing the suppression circuit with high voltage isolation and surge suppression.

### DETAILED DESCRIPTION OF THE EMBODIMENTS

Refer to the figure. A suppression circuit with high voltage isolation and surge suppression disclosed in the invention includes a safety capacitor 11 and an inductance 12. One end of the safety capacitor 11 is coupled to the signal source 13, and the other end is coupled to the modulator 14; one end of the inductance 12 is coupled to the safety capacitor 11 and the modulator 14, and the other end is coupled to the ground GND. Since the safety capacitor has the characteristic of surge endurance, when the signal source 13 receives the surge, the surge is not be transmitted to the modulator 14 or the related electronic components, so that the surge can be suppressed. On the other hand, when the signal source 13 receives a high voltage signal, the high voltage signal can be led to the ground GND via the bypass formed by the inductance 12 and the ground GND, so that the voltage signal is not be transmitted to the modulator 14 or the related electronic components, and the objective of voltage isolation can be achieved.

The safety capacitor 11 is cheap, so the cost of the overall circuit can be big reduced by replacing the conventional varistor (or called surge absorber) and gas tube with the safety capacitor 11 to improve the industry competitiveness. At the same time, the reliability of the safety capacitor 11 is better than the varistor (or called surge absorber) and the gas tube, so the suppression for the surge of the suppression circuit in the embodiment of the invention has better reliability than the conventional circuit and has better protection for the components at the after end.

On the other hand, if the circuit is used in high-frequency (HF) transmission, that is, if the signal source 13 is a high-frequency signal source (such as coaxial cable connector), the shielding performance is paid more attention to, so that the safety capacitor 11 and inductance 12 can be designed as surface mount devices (SMD). Therefore, the safety capacitor 11 and inductance 12 are mounted on the surface of the circuit when they are assembled to the circuit, and the back surface of the circuit can be laid copper and the HF shielding needs only to be designed at one surface of the components, so that the HF shielding performance is better. Of cause, the safety capacitor 11 and inductance 12 also can be design in dual in-line package (DIP) form and welded at the back surface of the circuit, so that the back surface of the circuit also needs the shielding cover to achieve the requirement of the shielding performance.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. A suppression circuit with high voltage isolation and surge suppression comprising:
a safety capacitor for isolating a surge, wherein one end of the safety capacitor is coupled to a high-frequency signal source, and another end of the safety capacitor is coupled to a modulator; and
an inductance, wherein one end of the inductance is coupled to the safety capacitor and the modulator, while another end is connected to a ground to form a bypass, and the inductance leads a high voltage signal to the ground via the bypass.

2. The suppression circuit with high voltage isolation and surge suppression according to claim 1, wherein the safety capacitor is a surface mount device (SMD).

3. The suppression circuit with high voltage isolation and surge suppression according to claim 1, wherein the inductance is a surface mount device (SMD).

4. The suppression circuit with high voltage isolation and surge suppression according to claim 1, wherein the high-frequency signal source is a connector.

5. The suppression circuit with high voltage isolation and surge suppression according to claim 4, wherein the connector is a coaxial cable connector.
